(19) United States
(12) Patent Application Publication
(10) Pub. No.: US 2024/0284583 A1
(43) Pub. Date: Aug. 22, 2024

(54) Device for Generating an Atmospheric Plasma Jet for Treating a Surface of a Workpiece

(71) Applicant: Plasmatreat GmbH, Steinhagen (DE)

(72) Inventors: Christian Buske, Bielefeld (DE); Magnus Buske, Steinhagen (DE)

(21) Appl. No.: 18/567,927

(22) PCT Filed: Jun. 8, 2022
(86) PCT No.: PCT/EP2022/065479

§ 371 Date: Dec. 7, 2023

(30) Foreign Application Priority Data
Jun. 10, 2021 (DE) 10 2021 115 020.5

(51) Int. Cl. H05H 1/34

(52) U.S. Cl. CPC H05H 1/3478; H05H 1/3463

(57) ABSTRACT

The invention relates to an apparatus for generating an atmospheric plasma jet for treating a surface of a workpiece with a plasma nozzle which is configured to generate an atmospheric plasma jet. The plasma nozzle has a nozzle arrangement with a nozzle opening for discharging a plasma jet to be generated in the plasma nozzle. The nozzle arrangement is rotatable about an axis of rotation and wherein the nozzle opening has a cross-section with a shape differing from a circular shape.

### CROSS-REFERENCE TO RELATED APPLICATIONS

This application is the United States national phase of International Application No. PCT/EP2022/065479 filed Jun. 8, 2022, and claims priority to German Patent Application No. 10 2021 115 020.5 filed Jun. 10, 2021, the disclosures of which are hereby incorporated by reference in their entireties.

### BACKGROUND OF THE INVENTION

### Field of the Invention

The present invention relates to an apparatus for generating an atmospheric plasma jet for treating a surface of a workpiece with a plasma nozzle which is configured to generate an atmospheric plasma jet, wherein the plasma nozzle has a nozzle arrangement with a nozzle opening for discharging a plasma jet to be generated in the plasma nozzle and wherein the nozzle arrangement is rotatable about an axis of rotation. The invention also relates to a method for treating a surface of a workpiece with such an apparatus.

### Description of Related Art

In the context of this description, a surface pretreatment, by means of which the surface energy can be changed and improved wettability of the surface with fluids can be achieved, is in particular regarded as a treatment of a surface with a plasma jet. A surface coating, in which, by adding at least one precursor to the plasma jet, a surface coating is achieved by means of a chemical reaction taking place in the plasma jet and/or on the surface of the workpiece whereby at least some of the chemical products are deposited, can further be regarded as treatment of the surface. Furthermore, surface treatment can also mean cleaning, disinfecting or sterilizing of the surface.

An apparatus for generating an atmospheric plasma jet for treating the surface of a workpiece with a plasma jet rotating about an axis is known from EP 1 067 829 B1. This apparatus has a tubular housing having an axis A, an internal electrode arranged inside the housing, which internal electrode preferably runs parallel to the axis A or, in particular, is arranged in the axis A. During operation of the apparatus, an electrical voltage is applied to the inner electrode, which produces an electrical discharge that generates a plasma by interacting with the working gas flowing inside the housing. The plasma is transported further together with the working gas.

Furthermore, the apparatus has a nozzle arrangement with a nozzle opening for discharging a plasma jet to be generated in the housing, whereby the nozzle arrangement is preferably arranged at the end of the discharge path, is grounded and channels the outflowing gas and plasma jet. The direction of the nozzle opening runs at an angle to the axis A, wherein the direction of the nozzle opening can be assumed to be parallel to the central direction of the outflowing plasma jet. To this end, a channel within the nozzle arrangement runs in an arcuate manner to deflect the gas and plasma jet from the inside of the housing. Finally, the nozzle arrangement is rotatable relative to the axis A, wherein the nozzle arrangement is either rotatable relative to the housing and the inner electrode or is connected to the housing in a rotationally fixed manner, while the housing rotates relative to the inner electrode. For the rotary movement, the nozzle arrangement or, respectively, the nozzle arrangement and the housing are driven by a motor.

A system for treating a surface with atmospheric plasma is known from EP 0 986 939 B1 and comprises two apparatuses for generating an atmospheric plasma jet, each of the two apparatuses having a tubular housing which has an axis A or A′, respectively, an inner electrode arranged within the housing and a nozzle arrangement having a nozzle opening for discharging a plasma jet to be generated in the housing, wherein the two apparatuses are connected to one another rotatably about a common axis B and wherein a drive is provided for generating a rotary movement of the apparatuses about the axis (B).

With both apparatuses or systems described above, it is possible to create a relatively wide treatment track by moving the rotating plasma jets along the surface of the workpiece to be treated. These techniques are therefore widely used.

Even if several tracks of plasma treatment of the surface parallel to one another and partially overlapping allow larger areas to be plasma treated, there are differences in the intensity of the plasma treatment on the surface transverse to the direction of movement of the apparatus or system, respectively. This effect is explained in more detail with reference to FIG. 1a-b.

FIG. 1a shows the treatment track of a plasma jet of an apparatus described above, with the trajectory (line) representing the point of impact of the maximum plasma intensity. The apparatus is moved in the y-direction, i.e. upwards in FIG. 1, in order to continuously apply the rotating plasma jet over a strip with an approximate width dx and treat the surface with plasma. The direction of movement (y) results in the effect that the outer areas of the treatment track (dx) in the area of the dotted lines are treated more intensively with the plasma than it is the case for the central areas of the treatment track.

This leads to the intensity distribution shown in FIG. 1b, which has two maxima that occur in the outer areas of the treatment track, indicated by the dashed lines. In between, there is only a noticeably lower intensity of the plasma treatment, so that an intensity minimum occurs in the middle of the treatment track.

For this reason, the surface is only unsatisfactorily plasma-treated and also insufficiently plasma-treated in regular strips. This means that the speed of movement of the apparatus relative to the surface must be slowed down regularly in order to achieve saturation of the plasma treatment also in the middle areas of the treatment track. This limits the use of the apparatus.

To solve this problem, WO 2017/097694 A1 proposes an apparatus for generating an atmospheric plasma jet with a rotating nozzle arrangement and a shield surrounding the nozzle arrangement, which shield influences the intensity of the interaction of the plasma jet to be generated with the surface of the workpiece. The shield can already achieve a fairly good uniformity of the plasma jet for surface treatment. However, the contact of the plasma jet with the shield can lead to a weakening of the plasma jet.

### SUMMARY OF THE INVENTION

The present invention is therefore based on the technical problem of further developing the apparatus and system described in the outset as well as the method for treating the surface of a workpiece in such a way that the aforementioned disadvantages are at least partially eliminated and that a more uniform treatment of the surface is achieved.

In an apparatus for generating an atmospheric plasma jet for treating a surface of a workpiece with a plasma nozzle which is configured to generate an atmospheric plasma jet, wherein the plasma nozzle has a nozzle arrangement with a nozzle opening for discharging a plasma jet to be generated in the plasma nozzle, and wherein the nozzle arrangement is rotatable about an axis of rotation, this object is solved according to the invention in that the nozzle opening has a cross-section with a shape differing from a circular shape.

Preferably, the nozzle opening has a cross-section with a shape differing from a circular shape, so that the intensity in the center of a treatment track caused by the plasma jet on a surface is increased.

It was found that with a rotating nozzle arrangement, the cross-sectional shape of the nozzle opening can be used to influence the intensity distribution of the treatment track, so that in particular the treatment intensity can be made more uniform over the width of the treatment track. Furthermore, it was found that in this way a uniformization can be achieved without significant attenuation of the plasma jet.

The plasma nozzle is configured to generate an atmospheric plasma jet. For this purpose, the plasma nozzle can in particular have at least two electrodes, for example an inner electrode arranged in the housing and a counter electrode, which can for example be formed by the housing itself. Furthermore, the plasma nozzle can in particular have a working gas inlet through which working gas can be introduced into the plasma nozzle so that it flows through the plasma nozzle in an area between the electrodes.

The plasma nozzle also has a nozzle arrangement with a nozzle opening for discharging a plasma jet to be generated in the plasma nozzle. In particular, the nozzle opening can be arranged at an end of the housing opposite to a working gas inlet.

The nozzle arrangement is rotatable about an axis of rotation. For example, the nozzle arrangement can be rotatable relative to the remaining part of the plasma nozzle. However, it is also conceivable that the nozzle arrangement is configured to be rotatable together with another part of the plasma nozzle or together with the entire plasma nozzle. For this purpose, the nozzle arrangement can in particular be configured to be rotationally fixed to the plasma nozzle or the co-rotating part thereof.

For example, the plasma nozzle can have a housing with a housing axis, whereby the axis of rotation runs parallel to the housing axis or coincides with it. The housing axis can, for example, run in the direction of the main direction of extension of the housing. For example, the housing can be tubular, with the housing axis running in the direction of extension of the tubular housing.

It is conceivable, for example, that two plasma nozzles are provided with a respective nozzle opening, which plasma nozzles rotate around a common axis of rotation that for example runs parallel to the housing axis of a housing of one of the plasma nozzles, in particular in the middle between the two plasma nozzles.

The nozzle opening has a cross-section with a shape that differs from a circular shape. Preferably, the nozzle opening has a cross-section that tapers in a radial direction with respect to the axis of rotation. In this way, an asymmetrical cross-section of the nozzle opening is achieved, the cross-section of which tapers in one radial direction and widens in the opposite radial direction. In addition or in the alternative, the nozzle opening may preferably have a cross-section which has a larger extension in the radial direction with respect to the axis of rotation than transversely thereto. In this way, an asymmetrical cross-section of the nozzle opening is achieved with respect to its aspect ratio.

Tests have shown that the plasma jet is influenced by the cross-sectional shapes of the nozzle opening described above in such a way that a more uniform surface treatment is achieved with the plasma jet.

For example, it was possible to increase the treatment intensity in the central area of the treatment track by using such a cross-sectional shape of the nozzle opening. This effect is illustrated in FIG. 1c by the intensity profile which, in contrast to FIG. 1b, has a flat or only slightly wavy plateau shape. If adjacent treatment tracks are then overlapped on the surface in such a way that the intensity of the plateau is reached in sum in the overlapping areas, the surface is treated more evenly overall by the plasma jet. This uniformization is achieved in particular without further deflection of the plasma jet after it leaves the nozzle opening, which prevents a loss of energy from the plasma jet, for example due to deflection at a shield.

If the nozzle opening has a cross-section that tapers in a radial direction with respect to the axis of rotation, the cross-section preferably tapers in a radial direction towards the axis of rotation. In this way, the cross-section of the nozzle opening becomes smaller from the outside to the inside towards the axis of rotation. Surprisingly, it was found that such a design of the cross-section allows to increase the plasma intensity in the area close to the axis of rotation, which makes the plasma treatment more uniform.

Various embodiments of the apparatus are described below, wherein the individual embodiments can be combined with one another as desired.

In one embodiment, the nozzle opening has a cross-section with a radial extension with respect to the axis of rotation, wherein the center of gravity of the cross-section has a radial distance from the center of the radial extension. The radial distance is preferably at least 5%, more preferably at least 10% of the radial extension. This type of cross-sectional shape makes it possible to achieve a more uniform surface treatment.

The center of gravity S=(xₛ, yₛ) of the cross-section Q of the nozzle opening with an area F can be determined, for example, by integrating over the area of the cross-section Q using the following formulae, where:

$${x}_{S} = \frac{1}{F} {\int }_{Q} x d F ( x , y ) {y}_{S} = \frac{1}{F} {\int }_{Q} y d F ( x , y )$$

If, for example, the x-direction is selected in the radial direction with respect to the axis of rotation, the following preferably applies: xₛ=x_{M}+Dₓ, where x_{M} is the center of the extension of the nozzle opening in the radial x-direction and Dₓ is a radial distance that is preferably at least 5%, more preferably at least 10% of the radial extension of the nozzle opening.

In a further embodiment, the nozzle opening has a cross-section that is larger in the radial direction with respect to the axis of rotation than transversely thereto, preferably by a factor of at least 1.5, more preferably by a factor of at least 1.8, particularly preferably by a factor of at least 2, especially by a factor of at least 3. A more uniform surface treatment could also be achieved by such a cross-sectional shape.

In order to achieve a sufficient cross-sectional area of the nozzle opening, the nozzle opening preferably has a cross-section that has a larger extension in the radial direction with respect to the axis of rotation than transversely thereto by a maximum factor of 25, further preferably by a maximum factor of 15, particularly preferably by a maximum factor of 10.

In one embodiment, the nozzle opening is arranged eccentrically to the axis of rotation. In this way, when rotating the nozzle arrangement, a continuous exposure of a central area of a surface under the nozzle arrangement and thus its overtreatment or damage is prevented. For this purpose, the nozzle opening is preferably arranged completely outside the axis of rotation.

In a further embodiment, the cross-section of the nozzle opening is rectangular or elliptical. Such a cross-sectional shape is easy to manufacture in terms of production technology, which reduces the manufacturing costs for the apparatus. A rectangular cross-section of the nozzle opening is in particular aligned such that the longer side edges run essentially parallel to a radial direction and the shorter side edges run essentially transverse thereto. An elliptical cross-section of the nozzle opening is in particular aligned in such a way that the larger cross-sectional axis runs essentially parallel to a radial direction and the smaller cross-sectional axis runs essentially transverse thereto. In this way, good uniformization of surface treatment with the plasma jet can be achieved.

In a further embodiment, the cross-section of the nozzle opening is drop-shaped or trapezoidal. Such a cross-sectional shape has been shown in tests to have a very good uniforming effect on the plasma treatment of a surface. In particular, the narrower end of the drop-shaped or trapezoidal cross-section of the nozzle opening is arranged closer to the axis of rotation than the wider end.

In a further embodiment, the cross-section of the nozzle opening has a cross-sectional area of maximum 50 mm², preferably maximum 30 mm², in particular maximum 20 mm². This ensures that the pressure of the plasma jet is maintained and that the plasma jet remains sufficiently intense and directed for targeted treatment.

In a further embodiment, the direction of the nozzle opening runs at an angle in the range of 0 and 45° to the axis of rotation. The direction of the nozzle opening is in particular understood to mean to the direction in which the nozzle channel leading to the nozzle opening extends in the area of the nozzle opening. By limiting the angle of the nozzle opening direction to a maximum of 45°, an overall more intensive treatment of the surface to be treated is achieved.

In a further embodiment, the direction of the nozzle opening runs at an angle of at least 1°, preferably at least 5°, to the axis of rotation. In this way, the treatment track can be widened so that a larger area of a surface can be treated at the same time.

In a further embodiment, the apparatus has a rotary drive that is configured to rotate the nozzle arrangement around the axis of rotation. In this way, the rotation of the nozzle arrangement can be controlled in a targeted manner, preferably with a predeterminable rotation frequency. The rotation frequency is preferably in the range of 100 to 4000 revolutions per minute, more preferably 1000 to 3000 revolutions per minute. The rotary drive can be configured to rotate the nozzle arrangement about the axis of rotation relative to the remaining part of the plasma nozzle. Furthermore, the rotary drive can be configured to rotate a part of the plasma nozzle or the entire plasma nozzle together with the nozzle arrangement around the axis of rotation.

In a further embodiment, the plasma nozzle is configured to generate the atmospheric plasma jet by means of an arc-like discharge in a working gas, wherein the arc-like discharge is generated by applying a high-frequency high voltage between electrodes. In this way, a plasma jet can be generated that can be easily focused and is also well suited for plasma treatment of a surface. In particular, a plasma jet generated in this way has a relatively low temperature, so that damage to the surface can be prevented.

The high-frequency high voltage for generating a high-frequency arc-like discharge can, for example, have a voltage level in the range of 1-100 kV, preferably 1-50 kV, more preferably 1-10 kV, and a frequency of 1-300 kHz, in particular 1-100 kHz, preferably 10-100 kHz, more preferably 10-50 KHz.

The object named above is further solved by a method for treating a surface of a workpiece with an apparatus described above or an embodiment thereof, in which the nozzle arrangement is rotated about the axis of rotation, in which an atmospheric plasma jet is generated with the plasma nozzle so that it emerges from the nozzle opening, and in which the plasma jet is directed onto the surface to be treated.

Preferably, the plasma nozzle is moved over the surface to be treated and/or the surface to be treated is moved along the plasma nozzle. In this way, a larger surface area can be treated. In addition, the resulting superimposed movement of the rotating plasma jet with the movement over the surface further improves the uniformization of the treatment.

### BRIEF DESCRIPTION OF THE DRAWINGS

Further advantages and features of the invention are apparent from the following description of several exemplary embodiments, wherein reference is made to the accompanying drawing.

In the drawing

FIG. 1a-c show graphic illustrations to explain the effect of the plasma treatment in the prior art and according to the present invention,

FIG. 2 shows an apparatus from the state of the art,

FIG. 3a-b a first exemplary embodiment of the apparatus for generating a plasma jet,

FIG. 4 a second exemplary embodiment of the apparatus for generating a plasma jet,

FIG. 5 a third exemplary embodiment of the apparatus for generating a plasma jet,

FIG. 6 a fourth exemplary embodiment of the apparatus for generating a plasma jet and

FIG. 7a-b a fifth exemplary embodiment of the apparatus for generating a plasma jet.

### DESCRIPTION OF THE INVENTION

In the following description of the various exemplary embodiments, corresponding components are provided with the same reference signs, even if the components may differ in their dimensions or shape in the various exemplary embodiments.

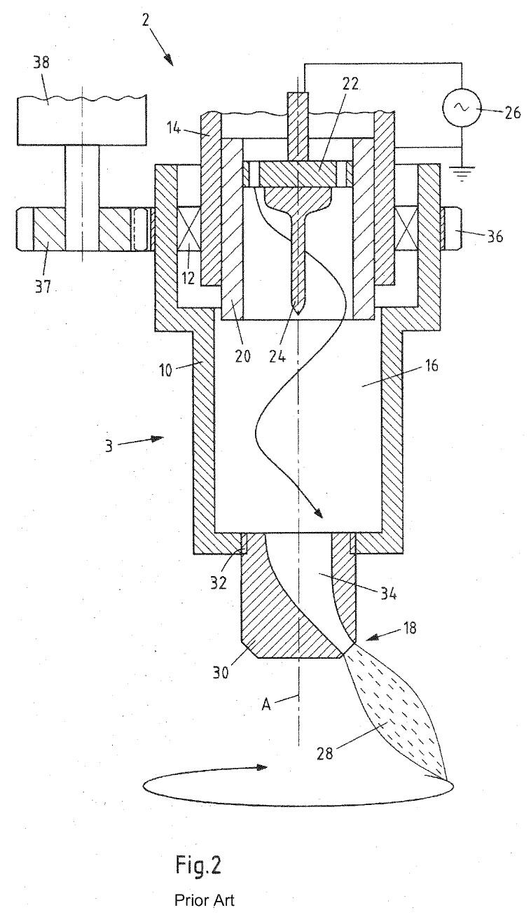

Before discussing a first exemplary embodiment of the apparatus described herein, the basic structure and operating principle of a plasma nozzle suitable for the apparatus described herein will first be explained using the prior art apparatus shown in FIG. 2.

The apparatus 2 shown in FIG. 2 and known from EP 1 067 829 B1 has a plasma nozzle 3, configured to generate a plasma jet, with a tubular housing 10, which is widened in diameter in its—with respect to the drawing-upper area and is rotatably mounted on a fixed support tube 14 with the aid of a bearing 12. Inside the housing 10, the upper part of a nozzle channel 16 is formed, which leads from the open end of the support tube 14 or from the working gas inlet, respectively, into the plasma nozzle 3 to a nozzle opening 18.

An electrically insulating ceramic tube 20 is inserted into the support tube 14. A working gas, for example air, is fed through the support tube 14 and the ceramic tube 20 into the nozzle channel 16. By means of a swirl device 22 inserted into the ceramic tube 20, the working gas is swirled such that it flows in a vortex through the nozzle channel 16 in the direction of the nozzle opening 18, as symbolized in the drawing by a helical arrow. This creates a vortex core in the nozzle channel 16, which runs along the axis A of the housing 10.

A pin-shaped inner electrode 24 is mounted on the swirl device 22, which inner electrode projects coaxially into the upper part of the nozzle channel 16 and to which inner electrode a high-frequency high voltage is applied with the aid of a high-voltage generator 26. The high-frequency high voltage can have a voltage strength in the range of 1-100 kV, preferably 1-50 kV, more preferably 1-10 kV, and a frequency of 1-300 kHz, in particular 1-100 kHz, preferably 10-100 kHz, more preferably 10-50 kHz. The high-frequency high voltage can be a high-frequency AC voltage, but also a pulsed DC voltage or a superposition of both voltage forms.

The metal housing 10 is grounded via the bearing 12 and the support tube 14 and serves as a counter-electrode so that an electrical discharge can be generated between the inner electrode 24 and the housing 10.

The inner electrode 24 arranged within the housing 10 is preferably aligned parallel to axis A; in particular, the inner electrode 24 is arranged in axis A.

The nozzle opening 18 of the nozzle channel is formed by a nozzle arrangement 30 made of metal, which is screwed into a threaded bore 32 of the housing 10 and in which a channel 34 is formed which tapers towards the nozzle opening 18 and is arcuate and inclined with respect to the axis A, which channel forms the lower part of the nozzle channel 16 to the nozzle opening 18. In this way, the plasma jet 28 emerging from the nozzle opening 18 forms an angle with the axis A of the housing, which is approximately 45° in the example shown. This angle can be varied as required by changing the nozzle arrangement 30.

The nozzle arrangement 30 is thus arranged at the end of the discharge path of the high-frequency arc discharge and is grounded via the metallic contact with the housing 10. The nozzle arrangement 30 thus channels the outflowing gas and plasma jet, with the direction of the nozzle opening 18 running at a predetermined angle to the axis A.

Since the nozzle arrangement 30 is connected to the housing 10 in a rotationally fixed manner and since the housing 10 is in turn rotatably mounted relative to the support tube 14 via the bearing 12, the nozzle arrangement 30 can rotate relatively about the axis A. In this embodiment, the axis of rotation therefore coincides with the housing axis A. A gear wheel 36 is arranged on the extended upper part of the housing 10, which is connected to a rotary drive 38, such as a motor, for example, via a toothed belt or a pinion 37.

During operation of the plasma nozzle 3 by the high-frequency high voltage, an arc discharge is generated between the inner electrode 24 and the housing 10 due to the high frequency of the voltage. The arc of this high-frequency arc discharge is carried along by the swirled incoming working gas and channeled in the core of the vortex-shaped gas flow, so that the arc then runs almost in a straight line from the tip of the inner electrode 24 along the axis A and only branches radially onto the housing wall or onto the wall of the nozzle arrangement 30 in the region of the lower end of the housing 10 or in the region of the channel 34, respectively. In this way, a plasma jet 28 is generated, which emerges through the nozzle opening 18.

The terms “arc” and “arc discharge” are used here as a phenomenological description of the discharge, as the discharge occurs in the form of an arc. The term “arc” is also used elsewhere as a form of discharge for DC discharges with essentially constant voltage values. In the present case, however, it is a high-frequency discharge in the form of an arc, i.e. a high-frequency arc discharge.

During operation, the housing 10 rotates at high speed around the axis A, so that the plasma jet 28 describes a conical surface which sweeps over the surface to be treated of a workpiece not shown. If the apparatus 2 or the plasma nozzle 3 is then moved along the surface of the workpiece or, conversely, the workpiece is moved along the apparatus 2 or plasma nozzle 3, a relatively uniform treatment of the surface of the workpiece is achieved on a strip whose width corresponds to the diameter of the cone described by the plasma jet 28 on the workpiece surface. The width of the pre-treated area can be influenced by varying the distance between the nozzle arrangement 30 and the workpiece. The plasma jet 28, which strikes the workpiece surface at an angle and is itself swirled, results in an intensive effect of the plasma on the workpiece surface. The swirl direction of the plasma jet can be in the same or opposite direction to the direction of rotation of the housing 10.

The intensity of the plasma treatment by the rotating plasma jet 28 depends on the distance of the nozzle opening 18 to the surface and the angle of incidence of the plasma jet 28 on the surface to be treated. In addition, the intensity of the plasma treatment depends on the traversing speed of the plasma nozzle 3 or the nozzle arrangement 30, respectively, relative to the surface of the workpiece.

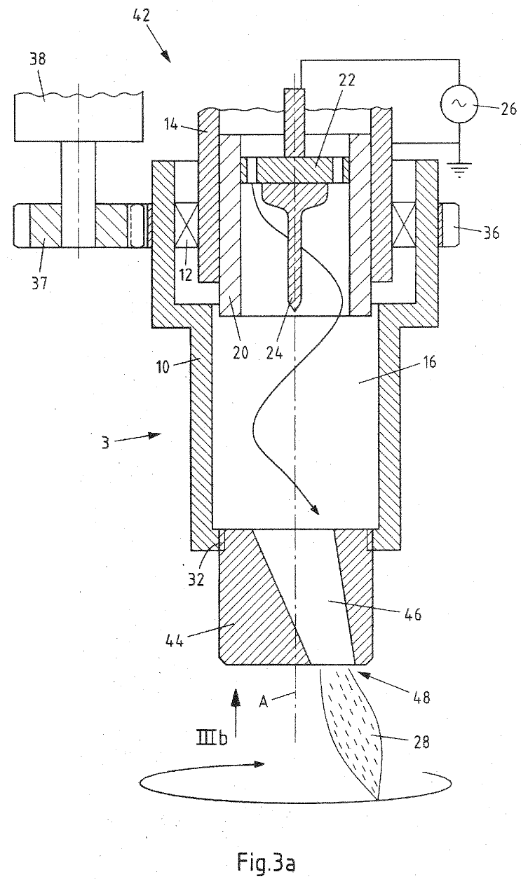

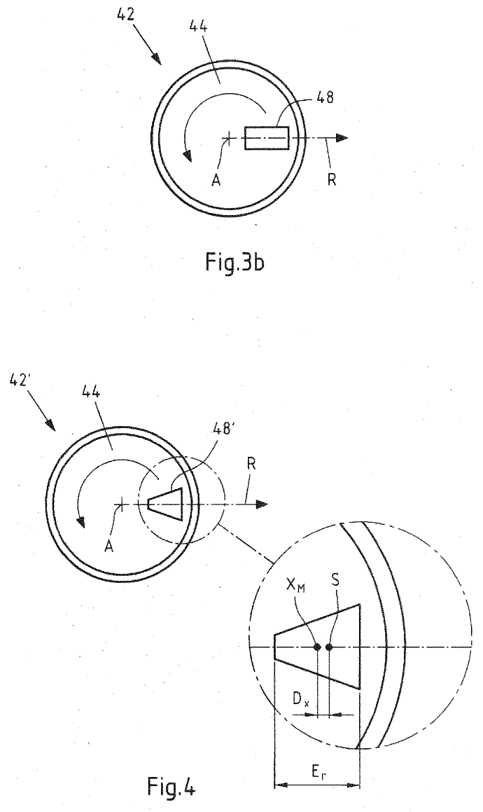

FIGS. 3a and 3b show a first exemplary embodiment of the apparatus disclosed herein. FIG. 3a shows a schematic cross-sectional view of the apparatus 42. The apparatus 42 has a similar structure to the apparatus 2 of FIG. 2, wherein corresponding components are provided with the same reference signs and reference is made in this respect to the above description of the apparatus 2.

The apparatus 42 differs from the apparatus 2 by a different nozzle arrangement 44 of the plasma nozzle 3. Like the nozzle arrangement 30, the nozzle arrangement 44 is screwed into a threaded bore 32 of the housing 10.

The nozzle arrangement 44 has a nozzle channel 46 with a nozzle opening 48, from which the plasma jet 28 emerges during operation. The nozzle channel 46 tapers towards the nozzle opening 18 and is inclined with respect to the axis A. In this way, the plasma jet 28 emerging from the nozzle opening 18 forms an angle with the axis A of the housing, which is approximately 30° in the example shown. In this exemplary embodiment, the axis A simultaneously designates the housing axis of the housing 10 and the axis of rotation coinciding therewith, about which axis of rotation the nozzle arrangement 44 is rotatable.

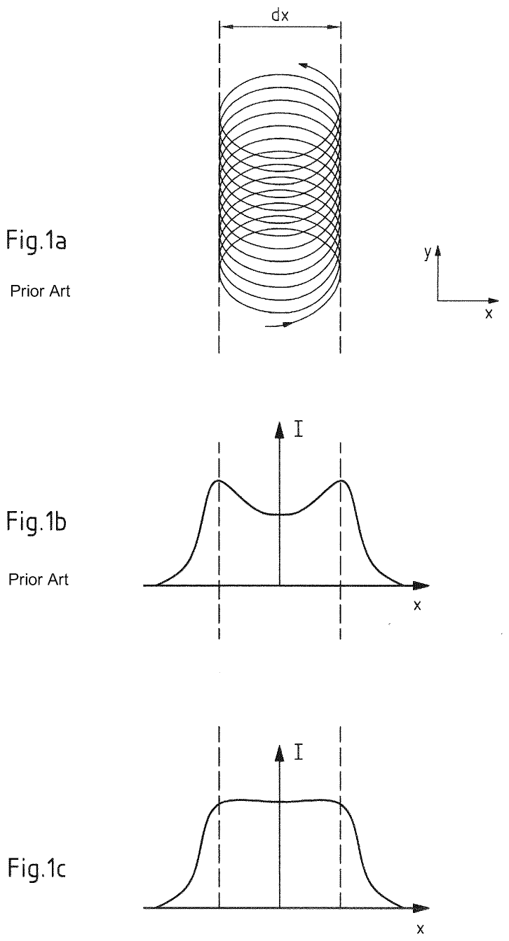

FIG. 3b shows the nozzle arrangement 44 with the nozzle opening 48 in a view from below. As FIG. 3b shows, the nozzle opening 48 has a rectangular cross-section, the long sides of which run parallel to a radial direction R, so that the cross-section has a greater extension in the radial direction with respect to the axis than transversely thereto, preferably by a factor of at least 1.5, more preferably of at least 2. It was found that the intensity of the plasma treatment can be shifted more strongly into the inner area with respect to the axis A when the nozzle arrangement 44 is rotated, so that the lower intensity in the middle of the treatment track occurring in the prior art (see FIG. 1b) is compensated for and a more uniform intensity results as shown in FIG. 1c. Instead of a rectangular shape as shown in FIG. 4, the nozzle opening can also have an elliptical cross-section, for example.

FIG. 4 shows a further exemplary embodiment of the apparatus. The apparatus 42′ has a basic structure like the apparatus 42 of FIG. 3a and differs from it only by a differently shaped nozzle opening 48′ and a correspondingly adapted nozzle channel. FIG. 4 shows the cross-section of the nozzle opening 48′ in a view of the apparatus 42′ from below corresponding to FIG. 3b.

As FIG. 4 shows, the nozzle opening 48′ has a trapezoidal cross-section, the narrower end of which is arranged closer to the axis than its wider end, so that the cross-section of the nozzle opening 48′ tapers in the radial direction towards the axis A. In particular, the center of gravity S thus has a radial distance Dₓ to the center x_{M} of the radial extension Er of the nozzle opening 48′.

It was found that, when the nozzle arrangement 44 is rotated, with a tapering of the nozzle opening cross-section in the direction of axis A, the intensity of the plasma treatment can be increased in this area, presumably due to flow effects, so that the lower intensity in the middle of the treatment track occurring in the prior art (see FIG. 1b) can also be compensated for in this way, resulting in a more uniform intensity as shown in FIG. 1c. Instead of a trapezoidal shape as shown in FIG. 4, the nozzle opening can also have a drop-shaped cross-section, for example.

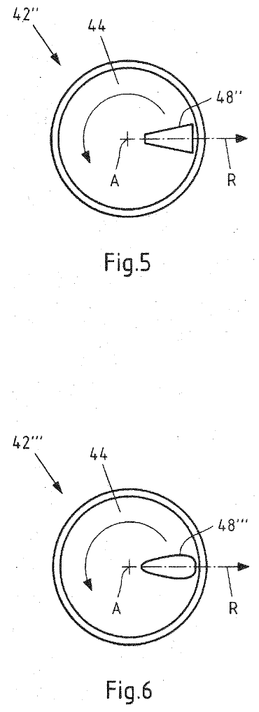

FIG. 5 shows a further exemplary embodiment of the apparatus. The apparatus 42″ has a basic structure like the apparatus 42 of FIG. 3a and differs from it only by a differently shaped nozzle opening 48″ and a correspondingly adapted nozzle channel. FIG. 5 shows the cross-section of the nozzle opening 48″ in a view of the apparatus 42″ from below corresponding to FIG. 3b.

As FIG. 5 shows, the nozzle opening 48″ has a trapezoidal cross-section like the nozzle opening 48′, which, as with the nozzle opening 48, also has a larger extension in the radial direction R with respect to the axis A than transversely thereto. In this way, the effects of the nozzle opening cross-sections from FIGS. 3b and 4 can be combined with each other, so that an even more uniform intensity can be achieved as shown in FIG. 1c.

FIG. 6 shows a further exemplary embodiment of the apparatus. The apparatus 42′″ has a basic structure like the apparatus 42 of FIG. 3a and differs from it only by a differently shaped nozzle opening 48′ and a correspondingly adapted nozzle channel. FIG. 6 shows the cross-section of the nozzle opening 48″ in a view of the apparatus 42″ from below corresponding to FIG. 3b.

As FIG. 6 shows, the nozzle opening 48″ has a drop-shaped cross-section that tapers in a radial direction in the direction of axis A. In addition, the cross-section has a larger extension in the radial direction R with respect to the axis A than transverse to it. With such a cross-section, a more uniform intensity can also be achieved when treating a surface.

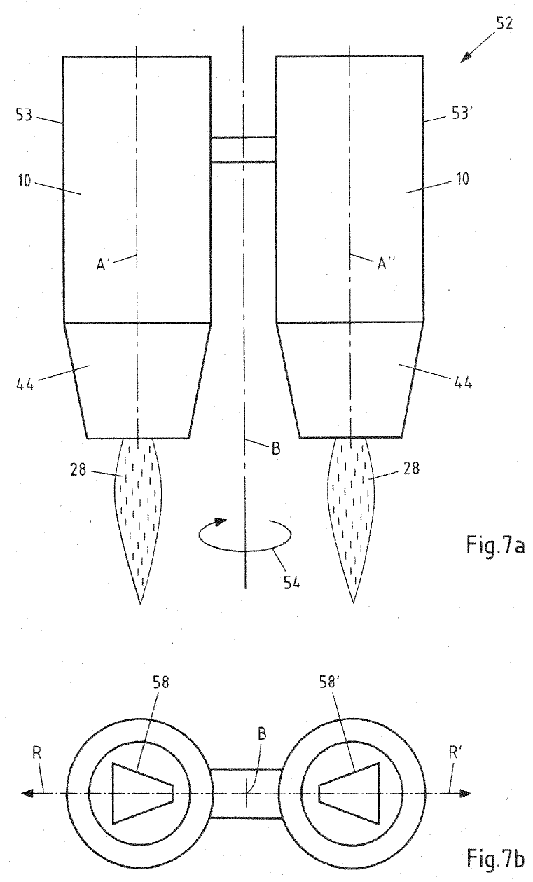

FIGS. 7a-b show a further exemplary embodiment of the apparatus. FIG. 7a shows a schematic side view. FIG. 7b shows a view from below. The apparatus 52 has two plasma nozzles 53, 53′ for generating a respective atmospheric plasma jet 28. The plasma nozzles 53, 53′ are connected to each other in a rotationally fixed manner and can be rotated about a common axis of rotation B by means of a drive provided (arrow 54). The axis of rotation B runs parallel to the housing axes A′, A″ of the tubular housings 10 of the plasma nozzles 53, 53′, respectively. In this exemplary embodiment, the axis of rotation B and the housing axes A′, A″ thus do not coincide.

The plasma nozzles 53, 53′ have a similar design and mode of operation to the plasma nozzle 3 in FIG. 3a-b. The plasma nozzles 53, 53′ differ from the plasma nozzle 3 in that the housing 10 is not rotatable relative to the support tube 14, in particular in that no bearing 12 is provided. Instead, the housing 10 and support tube 14 can be formed in one piece as a continuous housing. Accordingly, the plasma nozzles 53 and 53′ also lack the pinion 37 and rotary drive 38 shown in FIG. 3a. In addition, the nozzle openings 58, 58′ of the plasma nozzles 53, 53′ can run essentially parallel to the housing axes A′, A″ or to the axis of rotation B as shown in FIG. 7a or alternatively—similar to FIG. 3a—at an angle thereto.

As FIG. 7b shows, the nozzle openings 58, 58′ each have a trapezoidal cross-section whose respective narrower end is arranged closer to the axis of rotation B than its respective wider end, so that the cross-section of the nozzle openings 58, 58′ tapers towards the axis of rotation B in the radial direction R or R′. Alternatively, the nozzle openings 58, 58′ can also have a different cross-section, for example a cross-section as shown in FIG. 3b or in FIG. 6.

Tests were carried out to investigate the effect of the nozzle opening cross-section on the uniformity of the plasma treatment.

In these tests, a previously known apparatus corresponding to the apparatus 2 shown in FIG. 2 with a circular nozzle opening (apparatus V) and an apparatus corresponding to the apparatus 42′″ shown in FIG. 6 with a structure as shown in FIG. 3a and a drop-shaped nozzle opening as shown in FIG. 6 (apparatus E) were used.

The circular nozzle opening of apparatus V had a diameter of 4 mm. The drop-shaped nozzle opening of apparatus E had a length of 10 mm in the radial direction, a width transverse to the radial direction of 4 mm in the radially outer area and a width transverse to the radial direction of 1.5 mm in the radially inner area. The direction of the nozzle opening ran at an angle of 11° to the axis A.

Apparatuses V and E were each operated with air (75 l/min.) as the working gas and a high-frequency high voltage of around 5 kV at a frequency of 23 kHz. The rotation frequency of the nozzle arrangements around axis A was approx. 2800 revolutions per minute in each case.

Polyethylene test cards with an initial surface energy σ₀<30 mN/m were treated with the apparatuses V and E, whereby the apparatuses were each moved over the surface of the test cards to be treated at an advancement speed of 30 m/min.

After treatment, the surface energies of the test cards were measured in the center of each treatment track and at the edge of each treatment track.

The results of the surface energy measurements σ are shown in Table 1 below:

TABLE 1

| | Center of the | Edge of the |
|---|---|---|
| | treatment track | treatment track |
| Test card treated with | 38 mN/m | 65 mN/m |
| apparatus V | | |
| Test card treated with | 48 mN/m | 52 mN/m |
| apparatus E | | |

As the results in Table 1 show, the surface energy σ varies considerably less over the width of the treatment track for the test card treated with apparatus E than for the test card treated with apparatus V. This shows that the described design of the nozzle opening can achieve uniformity in the surface treatment as shown in FIG. 1c.

1. An apparatus for generating an atmospheric plasma jet for treating a surface of a workpiece
with a plasma nozzle which is configured to generate an atmospheric plasma jet,
wherein the plasma nozzle comprises at least two electrodes,
wherein the plasma nozzle is configured to generate the atmospheric plasma jet by means of an arc-like discharge in a working gas, the arc-like discharge being generated by applying a high-frequency high voltage between the electrodes,
wherein the plasma nozzle has a nozzle arrangement with a nozzle opening for discharging a plasma jet to be generated in the plasma nozzle, and
wherein the nozzle arrangement is rotatable about an axis of rotation,
wherein
the nozzle opening has a cross-section with a shape differing from a circular shape,
the nozzle opening has a cross-section which tapers in a radial direction with respect to the axis of rotation and/or which has a larger extension in the radial direction with respect to the axis of rotation that transversely thereto.

2. The apparatus according to claim 1,
wherein the plasma nozzle has a housing with a housing axis and the axis of rotation runs parallel to the housing axis or coincides with it.

3. (canceled)

4. The apparatus according to claim 1,
wherein the nozzle opening is arranged eccentrically to the axis of rotation.

5. The apparatus according to claim 1,
wherein the nozzle opening is arranged completely outside the axis of rotation.

6. The apparatus according to claim 1,
wherein the cross-section of the nozzle opening is rectangular or elliptical.

7. The apparatus according to claim 1,
wherein the cross-section of the nozzle opening is drop-shaped or trapezoidal.

8. The apparatus according to claim 1,
wherein the cross-section of the nozzle opening has a cross-sectional area of at most 50 mm², preferably at most 30 mm².

9. The apparatus according to claim 1,
wherein the direction of the nozzle opening runs at an angle in the range of 0 and 45° to the axis of rotation.

10. The apparatus according to claim 1,
wherein the direction of the nozzle opening runs at an angle of at least 1°, preferably at least 5°, to the axis of rotation.

11. The apparatus according to claim 1,
wherein the apparatus has a rotary drive which is configured to rotate the nozzle arrangement about the axis of rotation.

12. (canceled)

13. A method for treating a surface of a workpiece with an apparatus according to claim 1,
in which the nozzle arrangement is rotated about the axis of rotation,
in which an atmospheric plasma jet is generated with the plasma nozzle so that it emerges from the nozzle opening, and
in which the plasma jet is directed onto the surface to be treated.

14. The method according to claim 13,
in which the plasma nozzle is moved over the surface to be treated and/or the surface to be treated is moved along the plasma nozzle.
